(19) United States
(12) Patent Application Publication
(10) Pub. No.: US 2022/0284756 A1
(43) Pub. Date: Sep. 8, 2022

(54) ELECTRONIC EQUIPMENT

(71) Applicant: NEC Platforms, Ltd., Kawasaki-shi, Kanagawa (JP)

(72) Inventor: Yuta SASAKI, Kanagawa (JP)

(73) Assignee: NEC Platforms, Ltd., Minato-ku, Tokyo (JP)

(21) Appl. No.: 17/631,733

(22) PCT Filed: Aug. 3, 2020
(86) PCT No.: PCT/JP2020/029710

§ 371 Date: Jan. 31, 2022

(30) Foreign Application Priority Data
Aug. 8, 2019 (JP) 2019-146318

(51) Int. Cl. G07F 1/02; G07D 11/14; G07D 11/40; G07F 9/10

(52) U.S. Cl. CPC G07F 1/02; G07D 11/14; G07D 11/40; G07F 9/10

(57) ABSTRACT

In an electronic equipment including a coin handling apparatus, a protective cover having a plate-like shape for preventing infiltration of extraneous matters other than coins is attached to a coin insertion slot for inserting coins, and the protective over includes a cutout part having a size that allows a predetermined number of plurality of coins to simultaneously pass therethrough and a cutout part periphery section adjacent to the cutout part of the protective cover or a surface of the protective cover is formed to have a shape adapted to drain liquid falling on the protective cover.

### TECHNICAL FIELD

The present disclosure relates to an electronic equipment including a coin handling apparatus.

### BACKGROUND ART

In recent years, self-service checkouts regarding the checkout operation for payments at stores have become pervasive, and not only store clerks but also customers themselves are beginning to perform the payment work. Electronic equipment for performing self-checkout operations such as a self-service POS (Point of Sales) terminal apparatus and a self-service checkout apparatus (a register apparatus) not only include a banknote handing apparatus for handling banknotes installed therein but also a coin handling apparatus for handling coins. Further, such electronic equipment including a coin handling apparatus has a wide coin insertion slot that allows a plurality of coins to be simultaneously inserted therein.

There is a risk of an extraneous matter other than coins being accidentally inserted into the coin insertion slot. When a customer, who is not a trained store clerk, performs the checkout operation for the purchased product by himself/herself, there is a concern that the number of cases where extraneous matters other than coins are accidentally inserted into the coin insertion slot may increase.

In order to prevent such infiltration of extraneous matters, a technique is proposed in, for instance, Patent Literature 1, Unexamined Japanese Patent Application Publication No. 2013-088853 in which “a coin handling apparatus” has a lid member provided for an insertion part of a coin insertion slot and this lid is formed with a plurality of protrusions having such shapes that an extraneous matter other than coins, assuming that the extraneous matter is a small solid object such as a clip, is removed and only coins are moved to the coin insertion slot.

### CITATION LIST

### Patent Literature

Patent Literature 1: Unexamined Japanese Patent Application Publication No. 2013-088853

### SUMMARY OF INVENTION

However, with the current technology such as that disclosed in Patent Literature 1 and the like that is related to the present disclosure, it is not possible to simultaneously insert a plurality of coins.

### Object of the Present Disclosure

An object of the present disclosure is to provide an electronic equipment adapted reduce the risk of infiltration of extraneous matters including liquid such as water into a coin insertion slot into which a plurality of coins are simultaneously inserted.

In order to solve the aforementioned problem, an electronic equipment according to the present disclosure has the following main characteristic configuration.

An electronic equipment according to the present disclosure including a coin handling apparatus for handling coins inserted therein from a coin insertion slot, includes:

a protective cover having a plate-like shape for preventing infiltration of extraneous matters from the coin insertion slot; and

a cutout part having a size that allows a predetermined number of plurality of coins to simultaneously pass therethrough,

in which a cutout part periphery section adjacent to the cutout part of the protective cover or a surface of the protective cover is formed to have a shape adapted to drain liquid falling on the protective cover.

According to the present disclosure, it is possible to provide an electronic equipment adapted reduce the risk of infiltration of extraneous matters including liquid such as water into a coin insertion slot into which a plurality of coins are inserted simultaneously.

### BRIEF DESCRIPTION OF DRAWINGS

FIG. 1 is a perspective view showing an example of an electronic equipment that includes a coin handling apparatus according to the present disclosure;

FIG. 2A is a perspective view showing an example of a shape of a protective cover attached to a coin insertion slot of the electronic equipment shown in FIG. 1;

FIG. 2B is a perspective view showing the example of the shape of the protective cover that is attached to the coin insertion slot of the electronic equipment shown in FIG. 1;

FIG. 3A is a schematic diagram showing an example of a shape of the protective cover shown in FIGS. 2A and 2B;

FIG. 3B is a schematic diagram showing the example of the shape of the protective cover shown in FIGS. 2A and 2B;

FIG. 4A is a schematic diagram showing a first modified example in which the shape of the protective cover shown in FIGS. 2A and 2B is made different from that of the protective cover shown in FIGS. 3A and 3B;

FIG. 4B is a schematic diagram showing the first modified example in which the shape of the protective cover shown in FIGS. 2A and 2B is made different from that of the protective cover shown in FIGS. 3A and 3B;

FIG. 5A is a schematic diagram showing a second modified example in which the shape of the protective cover shown in FIGS. 2A and 2B is made different from that of the protective cover shown in FIGS. 3A and 3B and that of the protective cover shown in FIGS. 4A and 4B;

FIG. 5B is a schematic diagram showing the second modified example in which the shape of the protective cover shown in FIGS. 2A and 2B is made different from that of the protective cover shown in FIGS. 3A and 3B and that of the protective cover shown in FIGS. 4A and 4B;

FIG. 6A is a schematic diagram showing a third modified example in which the shape of the protective cover shown in FIGS. 2A and 2B is made different from that of the protective cover shown in FIGS. 3A and 3B, that of the protective cover shown in FIGS. 4A and 4B, and that of the protective cover shown in FIGS. 5A and 5B;

FIG. 6B is a schematic diagram showing the third modified example in which the shape of the protective cover shown in FIGS. 2A and 2B is made different from that of the protective cover shown in FIGS. 3A and 3B, that of the protective cover shown in FIGS. 4A and 4B, and that of the protective cover shown in FIGS. 5A and 5B;

FIG. 7A is a schematic diagram showing a fourth modified example in which the shape of the protective cover shown in FIGS. 2A and 2B is made different from that of the protective cover shown in FIGS. 3A and 3B, that of the protective cover shown in FIGS. 4A and 4B, that of the protective cover shown in FIGS. 5A and 5B, and that of the protective cover shown in FIGS. 6A and 6B;

FIG. 7B is a schematic diagram showing the fourth modified example in which the shape of the protective cover shown in FIGS. 2A and 2B is made different from that of the protective cover shown in FIGS. 3A and 3B, that of the protective cover shown in FIGS. 4A and 4B, that of the protective cover shown in FIGS. 5A and 5B, and that of the protective cover shown in FIGS. 6A and 6B;

FIG. 8A is a perspective view showing an example of a shape of a protective cover of a second example embodiment that is attached to an electronic equipment including a coin insertion slot having a shape different from the shape of the coin insertion slot of the electronic equipment shown in FIG. 1 as the first example embodiment;

FIG. 8B is a perspective view showing an example of a shape of the protective cover of the second example embodiment that is attached to the electronic equipment including the coin insertion slot having a shape different from the shape of the coin insertion slot of the electronic equipment shown in FIG. 1 as the first example embodiment; and

FIG. 8C is a perspective view showing an example of the protective cover of the second example embodiment that is attached to the electronic equipment including the coin insertion slot having a shape different from the shape of the coin insertion slot of the electronic equipment shown in FIG. 1 as the first example embodiment.

### DESCRIPTION OF EMBODIMENT

Hereinbelow, preferred example embodiments of an electronic equipment including a coin handling apparatus according to the present disclosure will be described with reference to the attached drawings. Note that in the following description, an electronic equipment including a coin handling apparatus will be described, however it is needless to mention that the electronic equipment may be a self-service POS terminal or a self-service checkout apparatus by which a customer performs, by oneself, the checkout operation in cash for the purchased product. Further, the reference symbols are assigned to the structural elements in each of the drawings mentioned below for the sake of assisting understanding of each element, and the present disclosure is not intended to be limited to the example embodiments shown in the drawings of the present disclosure.

### Features of the Present Disclosure

Before describing the present example embodiments, an overview of the features of the present disclosure will be described. The present disclosure is an electronic equipment including a coin insertion slot for inserting coins, and a main feature of the electronic equipment is that a protective cover of a plate-like shape having a cutout part of a size that allows a predetermined number of plurality of coins to pass therethrough simultaneously is attached to a surface of the coin insertion slot and the protective cover has a gutter or an inclined surface having such a shape that liquid falling on the protective cover is drained to the periphery of the cutout part. By this configuration, it is possible to reduce the risk of infiltration of extraneous matters other than coins into the coin insertion slot and even when liquid such as water and droplets spatter on the protective cover, it is possible to reduce the risk of infiltration of the liquid into the coin insertion slot.

Further, another feature is that by making the shape of the protective cover match the shape of the coin insertion slot, the protective cover can be made to fit various types of coin insertion slot.

### Configuration Example According to First Example Embodiment of the Present Disclosure

Next, a configuration example of an electronic equipment according to the present disclosure in a first example embodiment will be described with reference to the drawings.

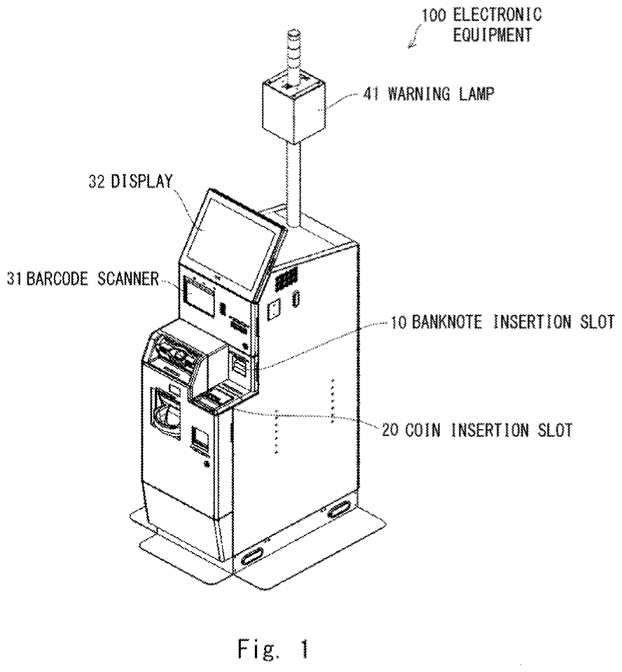

FIG. 1 is a perspective view showing an example of an electronic equipment that includes a coin handling apparatus according to the present disclosure. Here, as the electronic equipment, a self-service POS terminal apparatus for the customer oneself to register the product to be purchased and to perform the checkout operation for making payment of the purchase price is shown as an example.

As shown in FIG. 1, a self-service POS terminal apparatus, that is, an electronic equipment 100 includes, for performing the checkout operation in cash, a banknote insertion slot 10 for a banknote handling apparatus by which banknotes are handled, a coin insertion slot 20 for a coin handling apparatus by which coins are handled, and the like, as well as a barcode scanner 31 that reads the barcode of the product for registering the product, a display 32 that displays the payment information of the purchased product, and the like, and in addition, an warning lamp 41 for notifying shortage of cash and the like.

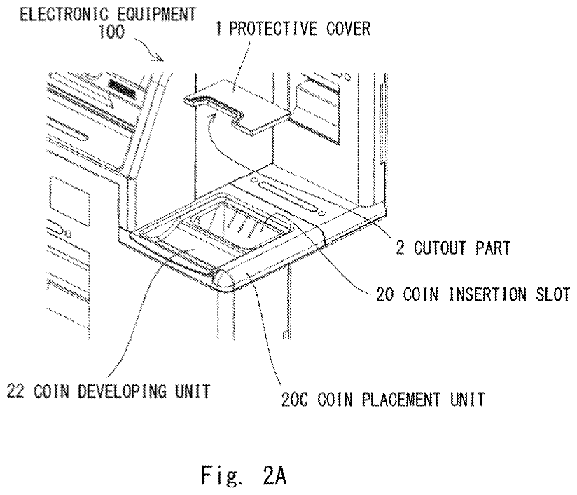

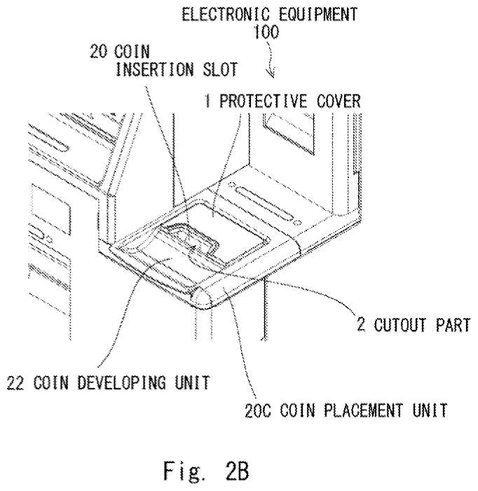

Here, although not shown in FIG. 1, in order to reduce the risk of infiltration of the extraneous matters including liquid such as water into the coin insertion slot, a protective cover 1 shown in FIGS. 2A and 2B serving as a protective cover that is peculiar to the present disclosure is attached to the coin insertion slot 20. FIGS. 2A and 2B are perspective views each showing an example of a shape of the protective cover 1 attached to the coin insertion slot 20 of the electronic equipment 100 shown in FIG. 1. FIG. 2A shows the state in which the protective cover 1 is about to be attached to the coin insertion slot 20 and FIG. 2B shows the state after the protective cover 1 has been attached to the coin insertion slot 20.

As shown in FIGS. 2A and 2B, the electronic equipment 100 has a coin insertion slot 20 forming a substantially rectangular opening for inserting coins and a coin developing unit 22 formed of a U-shaped recessed part for developing the coins formed to a coin placement unit 20C for placing coins for purchasing products. Here, the coin insertion slot 20 has an inclined surface by means of which the opening gradually narrows from the surface thereof toward the bottommost edge part thereof, and the bottommost edge part of the opening is linked with the coin insertion slot of the coin handling apparatus installed in the electronic equipment 100.

Further, as shown in FIGS. 2A and 2B, the protective cover 1 has a substantially rectangular plate-like shape. One side of the protective cover 1 (the front side in FIGS. 2A and 2B) has a cutout part 2 having a size that allows a predetermined number of plurality of coins to simultaneously pass therethrough formed therein. The predetermined number of plurality of coins are, for instance, two coins of the largest size (500 Japanese Yen coin). When the protective cover 1 is attached to the coin insertion slot 20, as shown in FIG. 2B, the whole surface part of the coin insertion slot 20 is covered, while the cutout part 2 is not covered. Then, when the protective cover 1 is attached to the surface of coin insertion slot 20, coins can be inserted into the coin insertion slot 20 only through the cutout part 2. Here, the protective cover 1 is bonded to the surface of the coin insertion slot 20 using an adhesive or the like so that they are brought into close contact with each other, and thus infiltration of any extraneous matters other than coins including liquid such as water and droplets from the periphery other than the cutout part 2 of the protective cover 1 into the coin insertion slot 20 can be completely prevented.

Further, when the customer performs, by himself/herself, the checkout operation for the purchased product, the customer develops the coins for payment to the coin developing unit 22, picks out the appropriate coins from the developed coins, takes out the picked-out coins from the coin developing unit 22, and inserts the picked-out coins that have been taken out into the coin insertion slot 20 through the cutout part 2 of the protective cover 1, whereby it is possible to reduce the risk of infiltration of the extraneous matters other than the coins into the coin insertion slot 20.

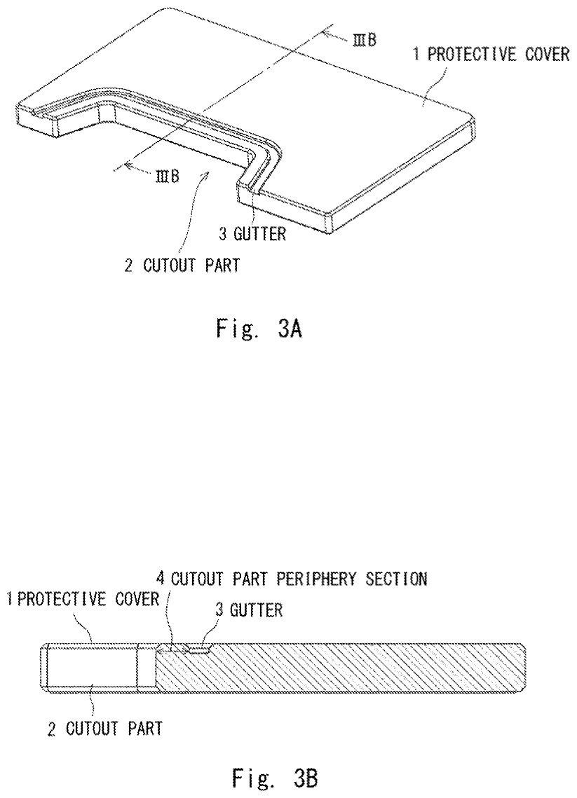

Next, the shape of the protective cover 1 shown in FIGS. 2A and 2B will be described in detail. FIGS. 3A and 3B are schematic diagrams each showing an example of a shape of the protective cover 1 shown in FIGS. 2A and 2B. FIG. 3A shows a schematic view of the protective cover 1 and FIG. 3B shows a cross-sectional shape of the protective cover 1 viewed in the direction of the arrow along the line IIIB-IIIB in FIG. 3A.

As shown in FIG. 3, a gutter 3 is formed on the surface of the protective cover 1 along an edge side of a cutout part periphery section 4. The cutout part periphery section 4 is a region that is adjacent to the cutout part 2 and having a fixed width. Therefore, it can be said that the gutter 3 is formed at a position on the edge side of the cutout part periphery section 4 opposing the cutout part 2, the cutout part periphery section 4 being adjacent to the cutout part 2 so as to be in parallel to the side of the protective cover 1 on which the cutout part 2 is formed, that is, the gutter 3 is formed along the edge side of the cutout part periphery section 4. The gutter 3 is a groove formed along the edge side of the cutout part periphery section 4 and has a shape adapted to drain liquid such as water that, when the coins are inserted, may fall on the protective cover 1, to the outside of the protective cover 1. As shown in the cross-sectional diagram of FIG. 3B, the gutter 3 has such a shape that an inclined side surface that gradually narrows toward the bottom surface thereof is formed so that liquid can be easily collected at the bottom surface.

That is, as shown in FIGS. 2A and 2B, in the electronic equipment 100, the protective cover 1 having a plate-like shape for reducing the risk of infiltration of extraneous matters other than coins into the coin insertion slot 20 for inserting coins is attached to the coin insertion slot 20 and the protective cover 1 includes the cutout part 2 having a size that allows a predetermined number of a plurality of coins to simultaneously pass therethrough and a surface shape of the cutout part periphery section 4 adjacent to the cutout part 2 in the protective cover 1 is formed to have such a shape adapted to drain liquid. In the examples shown in FIGS. 3A and 3B, the shape of the protective cover 1 adapted to drain liquid is a shape in which the gutter 3 for draining liquid to the outside of the protective cover 1 is formed along an edge side of the cutout part periphery section 4 at a position on the edge side opposite to the cutout part 2 and the side surface of the gutter 3 is formed to have such a shape that it inclines in the direction in which the opening gradually narrows toward the bottom surface of the gutter 3.

Further, the shape of the bottom surface of the gutter 3 is designed to have such a shape that facilitates drainage of liquid from the gutter 3 to the outside without any of the liquid accumulating at the bottom surface. The bottom surface of the gutter 3 has such a shape that an inclined surface inclining from one edge part of the gutter 3 to the other edge part thereof in the longitudinal direction (for instance, in FIGS. 3A and 3B, the direction from the background side toward the front side of the figures) is formed so that the thickness of the part of the protective cover 1 in which the bottom surface of the gutter 3 is formed becomes gradually thinner toward the other edge part. Further, regarding the surface of the cutout part periphery section 4 of the protective cover 1 having a plate-like shape, it is desirable that the surface has an inclined surface inclining toward the direction opposite to the direction toward the cutout part 2, that is, the direction toward the gutter 3 so that the thickness of the cutout part periphery section 4 becomes gradually thinner toward the gutter 3.

By attaching the protective cover 1 having a shape like that of the protective cover shown in FIGS. 3A and 3B to the coin insertion slot 20 of the electronic equipment 100, it is possible to prevent infiltration of extraneous matters other than coins including liquid such as water into the coin insertion slot 20 excluding the cutout part 2 having a size that allows the predetermined number of plurality of coins to pass therethrough simultaneously. Further, even when liquid such as water falls on the cutout part peripheral section 4 adjacent to the cutout part 2, the liquid that has fallen flows down the gutter 3 and is drained instead of flowing to the cutout part 2 side, whereby it is possible to prevent liquid such as water from flowing into the coin insertion slot 20.

That is, by attaching the protective cover 1 having a shape as that shown in FIGS. 3A and 3B, it is possible to reduce the risk of infiltration of extraneous matters other than coins into the coin insertion slot 20 of the electronic equipment 100 such as the self-service POS terminal shown in FIG. 1.

### Modified Example of First Example Embodiment According to the Present Disclosure

Next, a modified example of the protective cover 1 of the electronic equipment according to the present disclosure in the first example embodiment will be described with reference to the drawings. The shape of the protective cover 1 for reducing the risk of infiltration of the extraneous matters other than coins into the coin insertion slot 20 is not limited to the shape shown in FIGS. 3A and 3B and may be any other shape adapted to drain liquid falling on the protective cover 1.

### First Modified Example

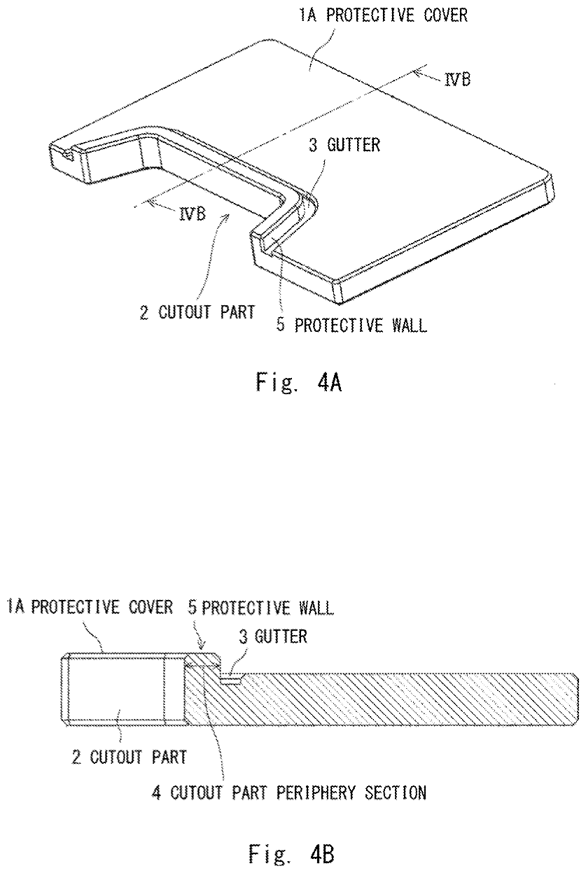

FIGS. 4A and 4B are schematic diagrams showing a first modified example in which the protective cover 1 shown in FIGS. 2A and 2B is formed to have a shape different from the shape of the protective cover shown in FIGS. 3A and 3B. FIG. 4A shows a perspective view of the protective cover 1A and FIG. 4B shows a cross-sectional shape of the protective cover 1A viewed in the direction of the arrow along the line IVB-IVB in FIG. 4A (the same direction as the direction along the line IIIB-IIIB in FIG. 3A).

As shown in FIGS. 4A and 4B, the gutter 3 like that of the protective cover 1 shown in FIGS. 3A and 3B is formed on the surface of the protective cover 1A at a position on the edge side of the cutout part periphery section 4 opposing the cutout part 2, the cutout part periphery section 4 being adjacent to the cutout part 2. The protective cover 1A shown in FIGS. 4A and 4B further has the cutout part periphery section 4 formed as a protective wall 5 that is thicker than the rest of the protective cover 1A having a plate-like shape as shown in the cross-sectional diagram of FIG. 4B.

Here, regarding the shape of the surface of the protective wall 5 formed to the cutout part periphery section 4 of the protective cover 1 having a plate-like shape, it is desirable that the thickness of the protective wall 5 becomes gradually thinner in the direction opposite to the direction of the cutout part 2 such that the surface of the protective wall has an inclined surface inclining in the direction opposite to direction of the cutout part 2, that is, an inclined surface inclining in the direction toward the gutter 3, so that even when liquid falls on the surface of the protective wall 5, the liquid easily flows easily toward the gutter 3 without flowing to the coin insertion slot side 20.

By attaching the protective cover 1A having a shape like that of the protective cover shown in FIGS. 4A and 4B to the coin insertion slot 20 of the electronic equipment 100, it is possible to prevent, like in the case of the protective cover 1 shown in FIG. 3A and 3B, infiltration of extraneous matters other than coins including liquid such as water into the coin insertion slot 20 excluding the cutout part 2 having a size that allows the predetermined number of plurality of coins to pass therethrough simultaneously. Furthermore, by forming the surface of the protective wall 5 formed to the cutout part periphery section 4 adjacent to the cutout part 2 to have such a shape that it inclines toward the direction opposite to the direction toward the cutout part 2, that is, toward the direction of the gutter 3, even when liquid such as water falls on the protective wall 5, the liquid that has fallen flows down the gutter 3 and drained instead of flowing to the cutout part 2 side, whereby it is possible to prevent the liquid from flowing into the coin insertion slot 20.

### Second Modified Example

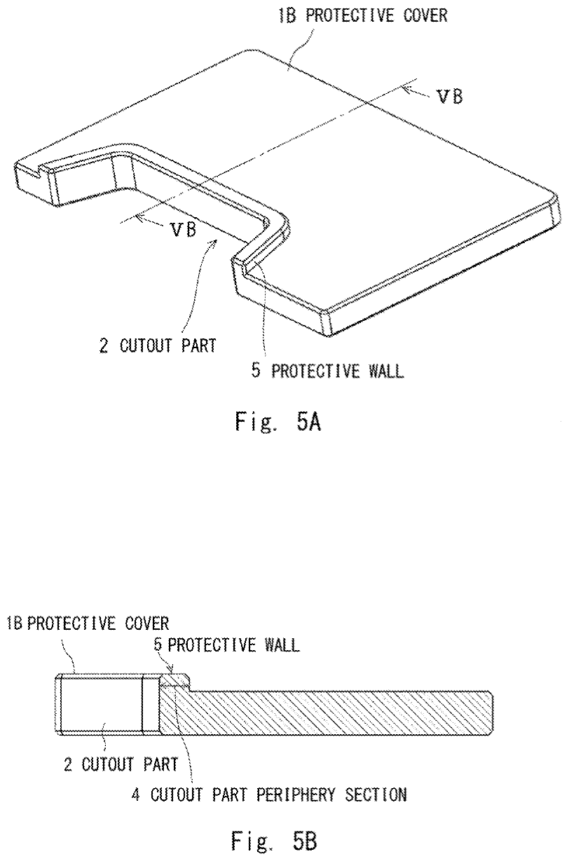

FIGS. 5A and 5B are schematic diagrams each showing a second modified example in which the protective cover 1 shown in FIGS. 2A and 2B is formed to have a shape different from the shape of the protective covers shown in FIGS. 3A and 3B and FIGS. 4A and 4B. FIG. 5A shows a perspective view of the protective cover 1B and FIG. 5B shows a cross-sectional shape of the protective cover 1B viewed in the direction of the arrow along the line VB-VB in FIG. 5A (the same direction as the direction along the line IIIB-IIIB in FIG. 3A).

As shown in FIGS. 5A and 5B, while the protective wall 5 is formed in the cutout part peripheral section 4 of the surface of the protective cover 1B like in the case of the protective cover 1B shown in FIGS. 4A and 4B, the gutter 3 is not formed at a position on the edge side of the cutout part periphery section 4 at a position opposing the cutout part 2 unlike the protective cover shown in FIGS. 3A and 3B and the protective cover shown in FIGS. 4A and 4B. Note that regarding the shape of the surface of the protective wall 5 formed to the cutout part periphery section 4 of the protective cover 1 having a plate-like shape, it is desirable that the thickness of the protective wall 5 becomes gradually thinner in the direction opposite to the cutout part 2 such that the surface of the protective wall 5 has an inclined surface inclining in the direction opposite to the direction of the cutout part 2 like in the case of the protective cover shown in FIGS. 4A and 4B.

By attaching the protective cover 1B having a shape like that of the protective cover shown in FIGS. 5A and 5B to the coin insertion slot 20 of the electronic equipment 100, it is possible to prevent infiltration of extraneous matters other than coins including liquid such as water into the coin insertion slot 20 excluding the cutout part 2 having a size that allows the predetermined number of plurality of coins to pass therethrough simultaneously like in the case of the protective cover shown in FIGS. 4A and 4B. Furthermore, by forming the surface of the protective wall 5 formed to the cutout part periphery section 4 adjacent to the cutout part 2 to have such a shape that the surface of the protective wall 5 inclines toward the direction opposite to the direction toward the cutout part 2, even when the liquid such as water falls on the protective wall 5, the liquid that has fallen flows down in the direction opposite to the direction of the cutout part 2 and discharged instead of flowing to the cutout part 2 side like in the case of the protective cover shown FIGS. 4A and 4B, whereby it is possible to prevent liquid from flowing into the coin insertion slot 20.

### Third Modified Example

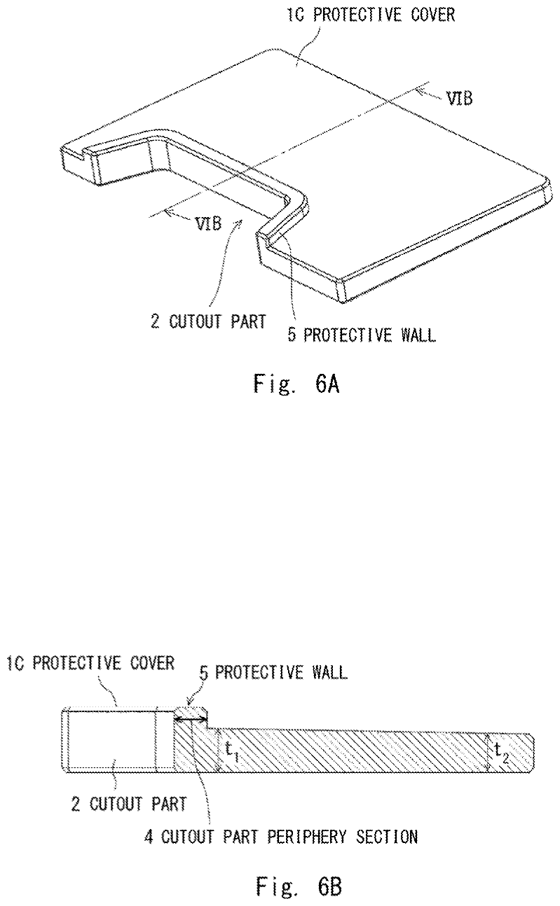

FIGS. 6A and 6B are schematic diagrams each showing a third modified example in which the protective cover 1 shown in FIGS. 2A and 2B is formed as a protective cover 1C having a shape different from the shape of any of the protective covers shown in FIGS. 3A and 3B, FIGS. 4A and 4B, and FIGS. 5A and 5B. FIG. 6A shows a perspective view of the protective cover 1C and FIG. 6B shows a cross-sectional shape of the protective cover 1C viewed in the direction of the arrow along the line VIB-VIB in FIG. 6A (the same direction as the direction along the line IIIB-IIIB in FIG. 3A).

As shown in FIGS. 6A and 6B, while the protective wall 5 is formed in the cutout part peripheral section 4 on the surface of the protective cover 1C like in the case of the protective cover 1B shown in FIGS. 4A and 4B, the gutter 3 is not formed at a position on the edge side of the cutout part periphery section 4 opposing the cutout part 2. The surface of the protective cover 1C shown in FIGS. 6A and 6B other than the cutout part periphery section 4 is formed to have an inclined surface inclining toward the direction opposite to the direction of the cutout part 2, that is, toward the direction of the side of the protective cover 1C opposite to the side thereof on which the cutout part 2 is formed so that the thickness of the part of the protective cover 1C other than the cutout part periphery section 4 becomes gradually thinner in the direction opposite to the direction toward the cutout part 2.

As shown in, for example, FIG. 6B, assuming that the thickness of the protective cover 1C in the vicinity of the cutout part periphery section 4 is denoted by t₁ and the thickness of the protective cover 1C in the vicinity of the side of the protective cover opposite to the side thereof on which the cutout part 2 is formed is denoted by t₂, the following relationship holds:

t₁>t₂

wherein the thickness of the protective cover 1C is formed to have such a shape that it becomes gradually thinner in the direction opposite to the direction toward the side on which the cutout part 2 is formed, that is, the side of the protective cover 1 opposite to the side thereof on which the cutout part 2 is formed.

Note that regarding the shape of the surface of the protective wall 5 formed on the cutout part periphery section 4 of the protective cover 1 having a plate-like shape, it is desirable that the thickness of the protective wall 5 becomes gradually thinner in the direction opposite to the direction toward the cutout part 2 such that the surface of the protective wall 5 has an inclined surface inclining in the direction opposite to the direction toward the cutout part 2 like in the case of the protective cover shown in FIGS. 4A and 4B.

Therefore, when liquid such as water falls on the surface of the protective cover 1C excluding the cutout part periphery unit 4, the liquid that has fallen flows down in the direction opposite to the direction toward the cutout part 2 and drained instead of flowing in the direction toward the cutout part 2 and thus it is possible to prevent the liquid from flowing down into the coin insertion slot 20. Note that regarding the shape of the surface of the protective wall 5 formed on the cutout part periphery section 4 of the protective cover 1 having a plate-like shape, it is desirable that the surface has an inclined surface inclining toward the direction opposite to the direction toward the cutout part 2 like in the case of the protective cover shown in FIGS. 4A and 4B.

### Fourth Modified Example

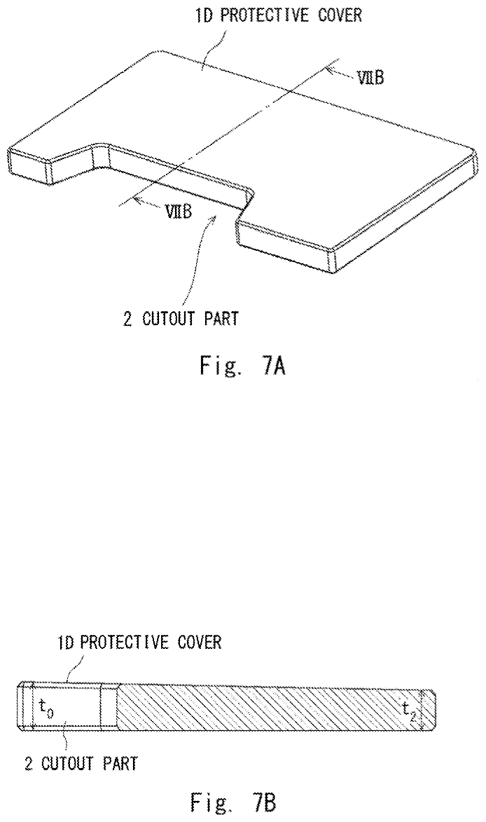

FIGS. 7A and 7B are schematic diagrams each showing a fourth modified example in which the protective cover 1 shown in FIGS. 2A and 2B is formed as a protective cover 1D having a shape different from the shape of any of the protective covers shown in FIGS. 3A and 3B, FIGS. 4A and 4B, FIGS. 5A and 5B, and FIGS. 6A and 6B. FIG. 7A shows a perspective view of the protective cover 1D and FIG. 7B shows a cross-sectional shape of the protective cover 1D viewed in the direction of the arrow along the line VIIB-VIIB in FIG. 7A (the same direction as the direction along the line IIIB-IIIB in FIG. 3A).

As shown in FIGS. 7A and 7B, the gutter 3 is not formed on the surface of the protective cover 1D at a position on the edge side of the cutout periphery section 4 opposite to the direction of the cutout part 2 like in the case of the protective cover shown of FIGS. 6A and 6B, and further, unlike the case shown in FIGS. 6A and 6B, the protective wall 5 is formed to the cutout part periphery section 4.

However, the surface of the protective cover 1D of FIGS. 7A and 7B is formed to have an inclined surface inclining from each edge side of the cutout part of the protective cover 1D to which the cutout part 2 is formed toward the outer periphery side so that the thickness of the protective cover 1D becomes gradually thinner in the direction opposite toward the cutout part 2.

As shown in, for example, FIG. 7B, assuming that the thickness of the protective cover 1D in the vicinity of the cutout part periphery section 2 is denoted by t₀and the thickness of the protective cover 1D in the vicinity of the side of protective cover opposing the side to which the cutout part 2 is formed is denoted by t₂, the following relationship holds:

t₀>t₂

wherein the thickness of the protective cover 1D becomes gradually thinner in the direction opposite to the direction toward the cutout part 2.

Note that it is even more desirable to form the cutout part such that the thickness of protective cover 1D becomes gradually thinner in the direction opposite to each edge side of the cutout part so that the surface of the protective cover 1D has a rounded inclined shape that is rounded with each edge side of the cutout part of the protective cover 1D as the tip end in such a way that the thickness of the protective cover becomes gradually thinner toward each side of the cutout part 2 of the protective cover 1D even towards the side of the protective cover 1D that is adjacent to the side of the protective cover 1D to which the cutout part 2 is formed.

By adopting the shape shown in FIGS. 7A and 7B, when liquid such as water falls on the surface of the protective cover 1D, the liquid that has fallen flows down in the direction opposite to the direction toward the cutout part 2 and drained instead of flowing to the cutout part 2 side, and thus it is possible to prevent liquid from flowing down into the coin insertion slot 20.

### Configuration Example According to Second Example Embodiment of the Present Disclosure

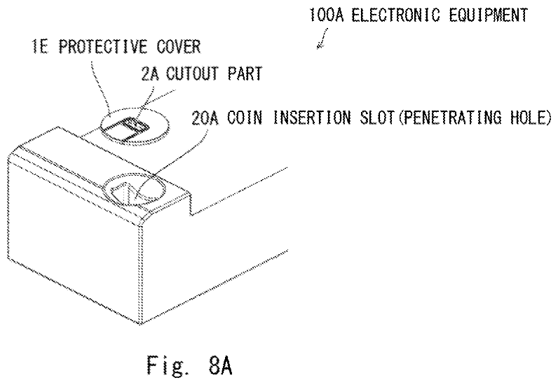

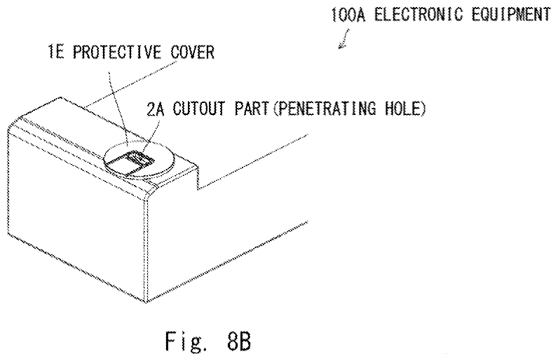

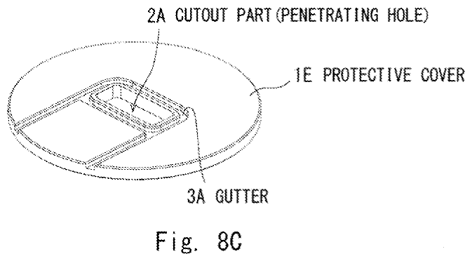

Next, a detailed description of a shape of the electronic equipment 100 according to the present disclosure in a second example embodiment will be described with reference to FIGS. 8A, 8B, and 8C.

FIGS. 8A, 8B, and 8C, are perspective views showing, as the second example embodiment, an example of the protective cover to be attached to an electronic equipment including a coin insertion slot having a shape that differs from the shape of the coin insertion slot 20 of the electronic equipment 100 shown in FIG. 1 as the first example embodiment. In the case of the aforementioned protective cover shown in FIGS. 1, 2A, and 2B as the first example embodiment, the electronic equipment 100 including the substantially rectangular coin insertion slot 20 has been given, while an electronic equipment 100A shown in FIGS. 8A, 8B and 8C as the second example embodiment includes a coin insertion slot 20A having a substantially circular shape. Further, as regards a protective cover 1E for reducing the risk of infiltration of extraneous matters other than coins into the coin insertion slot 20A shown in FIGS. 8A, 8B, and 8C, it has a substantially circular shape that fits the shape of the coin insertion slot 20A.

Note that FIG. 8A shows the state in which the protective cover 1E is about to be attached to the electronic equipment 100A including the coin insertion slot 20A having a substantially circular shape and FIG. 8B shows the state after the protective cover 1E has been attached to the electronic equipment 100A. Further, FIG. 8C shows a perspective view of the protective cover 1E having a substantially circular shape.

As shown in FIG. 8A, the coin insertion slot 20A having a substantially circular shape has an inclined surface by means of which the opening gradually narrows from the surface thereof toward the bottommost edge part thereof like in the case of the coins insertion slot 20 shown in FIGS. 2A and 2B of the first example embodiment, and the bottommost edge part of the opening is linked with the coin insertion slot of the coin handling apparatus (not shown in FIGS. 8A, 8B, and 8C) installed in the electronic equipment 100A.

Further, as shown in FIGS. 8A, 8B, and 8C, the protective cover 1E has a plate-like shape and has a cutout part 2A (in other words, a penetrating hole) having a size that allows a predetermined number of a plurality of coins to pass therethrough simultaneously formed near a center of the protective cover 1E. Further, the protective cover 1E is attached to the surface of the coin insertion slot 20A so as to cover the entire surface of the coin insertion slot 20A, while it does not cover the cutout part 2A (the penetrating hole) as shown in FIG. 8B as is also the case of the protective cover shown in FIG. 2B as the first example embodiment, and thus the coins can be inserted to the coin insertion slot 20A only through the cutout part 2A. The protective cover 1E is bonded to the surface of the coin insertion slot 20A using an adhesive or the like in the case of the protective cover shown in FIG. 2B, and infiltration of any extraneous matters other than coins including liquid such as water and droplets from the periphery other than through the cutout part 2A into the coin insertion slot 20A can be completely prevented.

As shown in FIG. 8C, the surface of the protective cover 1E has a gutter 3A in the cutout part periphery section that is hollowed out in a U-shape so as to surround the cutout part 2A that is adjacent to the cutout part 2A (the penetrating hole), and both of the edge parts of the gutter 3A reach the outer periphery part of the protective cover 1E.

The gutter 3A is a groove for draining, to the outside of the protective cover 1E, liquid such as water that may enter the coin insertion slot when coins are inserted, and like in the case of the gutter 3 shown in FIG. 3A and 3B as the first example embodiment, it has an inclined side surface that becomes gradually narrow towards the bottom surface thereof whereby the liquid is easily collected at the bottom surface.

Further, regarding the shape of the bottom surface of the gutter 3A, like in the case of the gutter 3 shown in FIGS. 3A and 3B as the first example embodiment, it inclines towards both of the edge parts from near the center of the gutter 3A in the longitudinal direction (a position substantially at the center of the cutout part periphery unit) so that liquid is easily drained to the outside from the gutter 3A without accumulating at the bottom surface thereof. Further, regarding the surface of the cutout part periphery section of the protective cover 1E having a plate-like shape, it is desirable that the thickness of the protective wall becomes gradually thinner in the direction opposite to the direction toward the cutout part 2A, that it, towards the direction of the gutter 3A, so that the surface of the cutout part periphery section has an inclined surface inclining in the direction opposite to the direction toward the cutout part 2A, that is, towards the direction of the gutter 3A.

By attaching the protective cover 1E having a substantially circular shape like that shown in FIG. 8 to the coin insertion slot 20A having a substantially circular shape of the electronic equipment 100A, it is possible to reduce the risk of infiltration of extraneous matters other than coins including liquid such as water into the coin insertion slot 20A, and only the cutout part 2A allows the predetermined number of plurality of coins to pass therethrough simultaneously like in the case of the protective cover of the first example embodiment. Furthermore, even when liquid such as water drops on the cutout part periphery section adjacent to the cutout part 2A, the liquid that has dropped flows down into the gutter 3A and drained instead of flowing toward the direction of the cutout part 2A and thus it is possible to prevent liquid from flowing into the coin insertion slot 20A.

That is, even when a coin insertion slot of the electronic equipment 100A such as the self-service POS terminal apparatus is the coin insertion slot 20A having a substantially circular shape, as shown in FIG. 8C, by attaching the protective cover 1E having a shape that matches the surface shape of coin insertion slot 20A, that is, a substantially circular shape, to the coin insertion slot 20A, it is possible to reduce the risk of infiltration of extraneous matters other than coins into the coin insertion slot 20A. Furthermore, by making the shape of the protective cover to be attached to the electronic equipment match the shape of the surface of the coin insertion slot to which the protective cover is attached in order to reduce the risk of infiltration of extraneous matters other than coins into the coin insertion slot, the protective cover can be made to fit various shapes of coin insertion slots.

The configurations of the preferred example embodiments of the present disclosure have been described above. However, it should be noted that the example embodiments are mere examples of the present disclosure are not intended to limit the present disclosure in any way. It should be easily understood by one skilled in the art that the present disclosure can be modified in various ways in accordance with the specific purpose without departing from the gist of the present disclosure.

This application is based upon and claims the benefit of priority from Japanese patent application No. 2019-146318, filed on Aug. 8, 2019, the entire contents of which are incorporated herein by reference.

### REFERENCE SIGNS LIST

1 PROTECTIVE COVER
1A PROTECTIVE COVER
1B PROTECTIVE COVER
1C PROTECTIVE COVER
1D PROTECTIVE COVER
1E PROTECTIVE COVER
2 CUTOUT PART
2A CUTOUT PART
3 GUTTER
3A GUTTER
4 CUTOUT PART PERIPHERY SECTION
5 PROTECTIVE WALL
10 BANKNOTE INSERTION SLOT
20 COIN INSERTION SLOT
20A COIN INSERTION SLOT
20C COIN PLACEMENT UNIT
22 COIN DEVELOPING UNIT
31 BARCODE SCANNER
32 DISPLAY
41 WARNING LAMP
100 ELECTRONIC EQUIPMENT (SELF-SERVICE POS TERMINAL APPARATUS)
100A ELECTRONIC EQUIPMENT

What is claimed is:

1. An electronic equipment including a coin handling apparatus for handling coins inserted therein from a coin insertion slot, comprising:
a protective cover having a plate-like shape for preventing infiltration of extraneous matters from the coin insertion slot; and
a cutout part having a size that allows a predetermined number of plurality of coins to simultaneously pass therethrough,
wherein a cutout part periphery section adjacent to the cutout part of the protective cover or a surface of the protective cover is formed to have a shape adapted to drain liquid falling on the protective cover so as to prevent liquid falling on the protective cover from flowing into the coin insertion slot, and
the shape adapted to drain liquid falling on the protective cover is a shape in which a gutter for draining liquid to the outside of the protective cover is formed along an edge side of the cutout part periphery section at a position on the side opposite to the cutout part in the cutout part periphery section.

2. (canceled)

3. The electronic equipment according to claim 1, wherein
the gutter has at least either one of a shape in which a side surface of the gutter inclines in a direction in which an opening gradually narrows toward a bottom surface of the gutter or a shape in which the bottom surface of the gutter has an inclined surface inclining from one edge part of the gutter to the other edge part thereof in a longitudinal direction so that a thickness of a part of the protective cover on which the bottom surface is formed becomes gradually thinner towards the other edge part, and
a surface of the cutout part periphery section is formed so as to have an inclined surface inclining toward the gutter such that a thickness of the cutout part periphery section becomes gradually thinner towards the gutter.

4. The electronic equipment according to claim 1, wherein the shape adapted to drain liquid falling on the protective cover is a shape in which
the cutout part periphery section is formed as a protective wall having a thickness that is thicker than the rest of the protective cover, and
the surface of the protective wall has an inclined surface inclining in the direction opposite to the direction toward the cutout part such that the thickness of the protective wall becomes gradually thinner in the direction opposite to the direction toward the cutout part.

5. The electronic equipment according to claim 1, wherein the shape adapted to drain liquid falling on the protective cover is a shape in which,
the cutout part periphery section is formed as a protective wall having a thickness that is thicker than the rest of the protective cover, and
the surface of the protective cover other than the cutout part periphery section has an inclined surface inclining in the direction opposite to the direction toward the cutout part such that the thickness of the protective cover becomes gradually thinner in the direction opposite to the direction toward the cutout part and,
the surface of the protective wall is formed so as to have an inclined surface inclining in the direction opposite to the direction toward the cutout part such that the thickness of the protective wall becomes gradually thinner in the direction opposite to the direction toward the cutout part.

6. The electronic equipment according to claim 1, wherein the shape adapted to drain liquid falling on the protective cover is a shape in which the surface of the protective cover is formed so as to have an inclined surface inclining in the direction opposite to the direction toward the cutout part such that the thickness of the protective cover becomes gradually thinner in the direction opposite to the direction toward to the cutout part.

7. The electronic equipment according to claim 1, wherein a shape of the protective cover is made to fit a shape of a surface of the coin insertion slot.

8. The electronic equipment according to claim 1, wherein the protective cover and the coin insertion slot are fixed to each other by adhesion using an adhesive so that the protective cover and the surface of the coin insertion slot come in close contact with each other.

9. The electronic equipment according to claim 1, wherein the self-service POS (Point of Sales) terminal or a self-service checkout apparatus by which a customer herself/himself performs a checkout operation for a purchased product in cash.
